(19) United States
(12) Patent Application Publication
(10) Pub. No.: US 2022/0343603 A1
(43) Pub. Date: Oct. 27, 2022

(54) THREE-DIMENSIONAL RECONSTRUCTION METHOD, THREE-DIMENSIONAL RECONSTRUCTION APPARATUS, DEVICE AND STORAGE MEDIUM

(71) Applicant: Beijing Baidu Netcom Science Technology Co., Ltd., Beijing (CN)

(72) Inventors: Bo Ju, Beijing (CN); Xiaoqing Ye, Beijing (CN); Xiao Tan, Beijing (CN); Hao Sun, Beijing (CN)

(21) Appl. No.: 17/862,588

(22) Filed: Jul. 12, 2022

(30) Foreign Application Priority Data
Aug. 25, 2021 (CN) 202110983352.3

(51) Int. Cl. G06T 17/20; G06T 7/73; G06V 20/64; G06V 10/26

(52) U.S. Cl. CPC G06T 17/205; G06T 7/75; G06V 20/647; G06V 10/26; G06T 2207/30196

(57) ABSTRACT

Three-dimensional reconstruction method, three-dimensional reconstruction apparatus, device, and storage medium are provided. An implementation of the method may include: determining, based on an initial three-dimensional human body model, a target two-dimensional image corresponding to the three-dimensional human body model; semantically segmenting the target two-dimensional image, and determining semantic labels of pixels in the target two-dimensional image; determining semantic labels of skinned mesh vertices according to corresponding relationships between the skinned mesh vertices in the initial three-dimensional human body model and the pixels in the target two-dimensional image; determining target weights of the skinned mesh vertices according to the semantic labels of the skinned mesh vertices; and determining a target three-dimensional human body model according to the target weights.

### CROSS-REFERENCE TO RELATED APPLICATIONS

This application claims priority to Chinese Patent Application No. 202110983352.3, filed with the China National Intellectual Property Administration (CNIPA) on Aug. 25, 2021, the content of which is incorporated herein by reference in its entirety.

### TECHNICAL FIELD

Embodiments of the present disclosure relate to the field of artificial intelligence, in particular to the field of computer vision and deep learning technologies, and particularly to three-dimensional reconstruction method, three-dimensional reconstruction apparatus, device and storage medium, which can be used in virtual human and augmented reality scenarios.

### BACKGROUND

Personalized 3D virtual human figures need to support basic controls such as real-time facial expressions, body movements and voice drives. These virtual figures may be widely used in social, games, online education, virtual anchors, virtual idols and other innovative interactive scenarios, to help video, live broadcast, social, video live broadcast and other platform users to find interesting and personalized new interactive modes.

The generation of the 3D virtual human figure includes a number of very critical steps, one of which is the generation of human skin. In short, it is to find the vertices in the 3D human mesh that can be truly deformed with the movement of the human skeletal system. Each of the vertices contains a skin weight, which drives the vertices of the 3D human surface according to the movement of the human bones. How to accurately determine the skin weights of individual vertices is a very important research aspect.

### SUMMARY

Embodiments of the present disclosure provide a three-dimensional reconstruction method, a three-dimensional reconstruction apparatus, a device and a storage medium.

In a first aspect, some embodiments of the present disclosure provide a three-dimensional reconstruction method. The method includes: determining, based on an initial three-dimensional human body model, a target two-dimensional image corresponding to the three-dimensional human body model; semantically segmenting the target two-dimensional image, and determining semantic labels of pixels in the target two-dimensional image; determining semantic labels of skinned mesh vertices according to corresponding relationships between the skinned mesh vertices in the initial three-dimensional human body model and the pixels in the target two-dimensional image; determining target weights of the skinned mesh vertices according to the semantic labels of the skinned mesh vertices; and determining a target three-dimensional human body model according to the target weights.

In a second aspect, an embodiment of the present disclosure provides a three-dimensional reconstruction apparatus. The three-dimension reconstruction apparatus includes: an image determination unit, configured to determine, based on an initial three-dimensional human body model, a target two-dimensional image corresponding to the three-dimensional human body model; a semantic segmentation unit, configured to semantically segment the target two-dimensional image, and determining semantic labels of pixels in the target two-dimensional image; a label determination unit, configured to determine semantic labels of skinned mesh vertices according to corresponding relationships between the skinned mesh vertices in the initial three-dimensional human body model and the pixels in the target two-dimensional image; a weight determination unit, configured to determine target weights of the skinned mesh vertices according to the semantic labels of the skinned mesh vertices; and a three-dimensional reconstruction unit, configured to determine a target three-dimensional human body model according to the target weights.

In a third aspect, some embodiments of the present disclosure provide an electronic device, which comprises: at least one processor; and a memory, in communication connection with the at least one processor, wherein, the memory stores instructions executable by the at least one processor, the instructions, when executed by the at least one processor, cause the at least one processor to implement the three-dimensional reconstruction method as described in the first aspect.

In a fourth aspect, some embodiments of the present disclosure provide a non-transitory computer readable storage medium, storing computer instructions thereon, the computer instructions when executed by a computer cause the computer to implement the method as described in the first aspect.

In a fifth aspect, some embodiments of the present disclosure provide a computer program product including a computer program, the computer program, when executed by a processor, cause the processor to implement the method as described in the first aspect.

The technology according to the present disclosure can quickly and accurately determine the weight of each skin vertex, thereby improving the speed and accuracy of three-dimensional reconstruction.

It should be understood that the content described in this section is not intended to identify key or important features of the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the present solution, and do not constitute a limitation to the present disclosure. In the drawings:

FIG. 1 is an exemplary system architecture to which embodiments of the present disclosure are applicable;

FIG. 2 is a flowchart of a three-dimensional reconstruction method according to an embodiment of the present disclosure;

FIG. 3 is a schematic diagram of an application scenario of a three-dimensional reconstruction method according to an embodiment of the present disclosure;

FIG. 4 is a flowchart of a three-dimensional reconstruction method according to another embodiment of the present disclosure;

FIG. 5 is a schematic structural diagram of a three-dimensional reconstruction apparatus according to an embodiment of the present disclosure; and

FIG. 6 is a block diagram of an electronic device used to implement a three-dimensional reconstruction method of an embodiment of the present disclosure.

### DETAILED DESCRIPTION

The following describes exemplary embodiments of the present disclosure with reference to the accompanying drawings, which includes various details of embodiments of the present disclosure to facilitate understanding, and they should be considered as merely exemplary. Therefore, those of ordinary skills in the art should recognize that various changes and modifications may be made to embodiments described herein without departing from the scope and spirit of the present disclosure. Also, for clarity and conciseness, descriptions of well-known functions and structures are omitted in the following description.

It should be noted that embodiments in the present disclosure and the features in the embodiments may be combined with each other on a non-conflict basis. Embodiments of the present disclosure will be described in detail below with reference to the accompanying drawings.

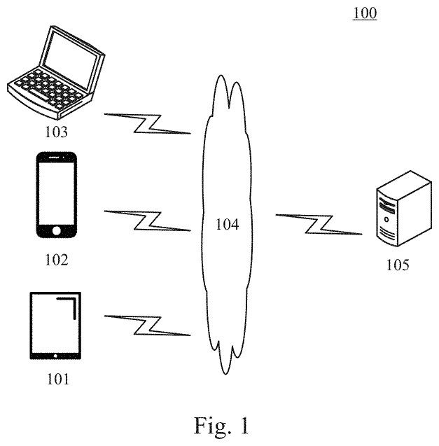

FIG. 1 illustrates an exemplary system architecture 100 to which embodiments of the three-dimensional reconstruction method and the three-dimensional reconstruction apparatus of the present disclosure are applicable.

As shown in FIG. 1, the system architecture 100 may include terminal device(s) 101, 102, 103, a network 104 and a server 105. The network 104 is used as a medium for providing a communication link between the terminal device(s) 101, 102, 103 and the server 105. The network 104 may include various connection types, such as wired, wireless communication links, fiber optic cables, and the like.

The user may use the terminal device(s) 101, 102, 103 to interact with the server 105 via the network 104 to receive or send messages and the like. Various communication client applications may be installed on the terminal device(s) 101, 102, 103, such as live broadcast applications, game applications, and the like.

The terminal device(s) 101, 102, 103 may be hardware or software. When the terminal device(s) 101, 102, 103 are hardware, they may be various electronic devices, including but not limited to smart phones, tablet computers, e-book readers, in-vehicle computers, laptop computers, and desktop computers. When the terminal device(s) 101, 102, 103 are software, they may be installed in the electronic device(s) listed above. It may be implemented as multiple software or software modules (for example, to provide distributed services), or as a single software or software module, which is not specifically limited herein.

The server 105 may be a server that provides various services, such as a background server that provides three-dimensional reconstruction algorithms to the terminal device(s) 101, 102, 103. The background server may send an optimized three-dimensional reconstruction algorithm to the terminal device(s) 101, 102, 103, so that the terminal device(s) 101, 102, 103 may display three-dimensional models in various applications.

It should be noted that the server 105 may be hardware or software. When the server 105 is hardware, it may be implemented as a distributed server cluster composed of multiple servers, or as a single server. When the server 105 is software, it may be implemented as a plurality of software or software modules (for example, to provide distributed services), or as a single software or software module, which is not specifically limited here.

It should be noted that the three-dimensional reconstruction method provided by embodiments of the present disclosure is generally performed by the terminal device(s) 101, 102, 103. Correspondingly, the three-dimensional reconstruction apparatus is generally provided in the terminal device(s) 101, 102, 103. In some scenarios, when the three-dimensional reconstruction algorithm is located locally on the terminal device(s) 101, 102, 103, the network 104 and the server 105 may not be included in the above architecture 100.

It should be understood that the numbers of terminal devices, networks and servers in FIG. 1 are merely illustrative. There may be any number of terminal devices, networks and servers according to implementation needs.

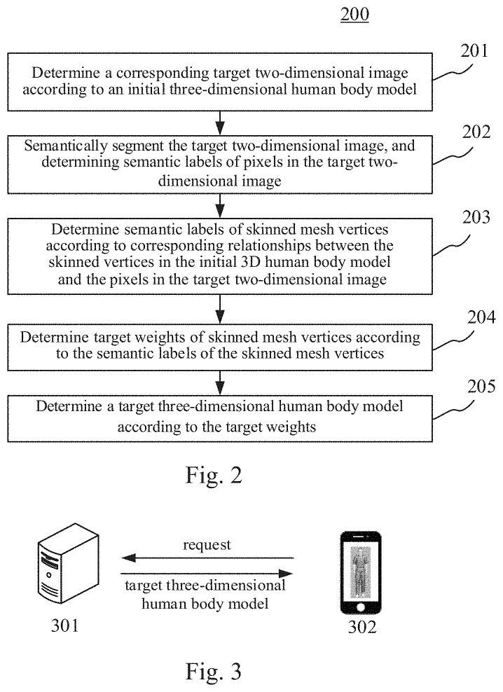

With further reference to FIG. 2, a flow 200 of a three-dimensional reconstruction method according to an embodiment of the present disclosure is shown. The three-dimensional reconstruction method of this embodiment includes the following steps:

Step 201, determining a corresponding target two-dimensional image according to an initial three-dimensional human body model.

In this embodiment, the executive body of the three-dimensional reconstruction method may first acquire an initial three-dimensional human body model. The above initial three-dimensional human body model may be a three-dimensional human body model constructed by a technician through a three-dimensional reconstruction application installed in the terminal device. The executive body may perform various processing on the initial three-dimensional human body model to determine the corresponding target two-dimensional image. In more detail, the executive body may project the initial three-dimensional human body model to the two-dimensional image plane to obtain the target two-dimensional image. Alternatively, the executive body may use an image processing application to render the initial three-dimensional human body model to obtain the corresponding target two-dimensional image. The target two-dimensional image may be a human body image, including various parts of the human body.

Step 202: semantically segmenting the target two-dimensional image, and determining semantic labels of pixels in the target two-dimensional image.

The executive body may use various algorithms to perform semantic segmentation on the target two-dimensional image, and determine the semantic labels of pixels in the target two-dimensional image. For example, the target two-dimensional image is input into a pre-trained semantic segmentation network, and the semantic labels of pixels in the target two-dimensional image are determined according to the output of the semantic segmentation network. Alternatively, the matching degree is calculated between the target two-dimensional image and the two-dimensional image pre-labeled with semantic labels, and the semantic labels of the pixels in the two-dimensional image with the highest matching degree are determined as the semantic labels of the pixels in the target two-dimensional image. The semantic labels may include: head, upper body, upper arm, lower arm, thigh, calf, and so on.

Step 203, determining semantic labels of skinned mesh vertices according to corresponding relationships between the skinned mesh vertices in the initial three-dimensional human body model and the pixels in the target two-dimensional image.

In this embodiment, the executive body may first acquire the corresponding relationships between the skin vertices in the initial three-dimensional human body model and the pixels in the target two-dimensional image. In more detail, the executive body may determine the above corresponding relationships through a three-dimensional model construction software. The pixels in the target two-dimensional image corresponding to the skinned mesh vertices in the initial three-dimensional human body model may be determined through the above corresponding relationships. A skinned mesh vertex and a pixel that correspond to each other may be used as a matching pair. The executive body may directly use the semantic label of the pixel as the semantic label of the matching skinned mesh vertex. Alternatively, the semantic label of the skinned mesh vertex may be determined according to the labels of the corresponding pixel and surrounding pixels.

Step 204: determining target weights of skinned mesh vertices according to the semantic labels of the skinned mesh vertices.

After determining the semantic labels of the skinned mesh vertices, the executive body may further determine the target weights of the skinned mesh vertices. In more detail, the executive body may determine the target weights of the skinned mesh vertices having different semantic labels, according to the preset corresponding relationships between the semantic labels and the weights. Alternatively, the executive body may input the position and semantic label of a skin vertex into a pre-trained weight determination model to obtain the target weight of the skin vertex.

Step 205: determining a target three-dimensional human body model according to the target weights.

In this embodiment, after determining the target weights, the executive body may apply the target, weights to the initial three-dimensional human body model to determine the target three-dimensional human body model. In more detail, according to the target weights, the executive body may further determine a driving coefficient of that a skeleton node drives a skinned mesh vertex or determine driving coefficients of that the skeleton node drives skinned mesh vertices, and use the above driving coefficient(s) to drive the initial three-dimensional human body model to obtain the target three-dimensional human body model.

Further referring to FIG. 3, which illustrates a schematic diagram of an application scenario of the three-dimensional reconstruction method according to an embodiment of the present disclosure. In the application scenario of FIG. 3, in a live broadcast platform, the user sends a request to the server 302 using the mobile phone 301, and the server 302 sends the target three-dimensional human body model generated by steps 201 to 205 to the mobile phone 301. In this way, the user can display the above target three-dimensional human body model in the mobile phone 301 for live broadcast.

The three-dimensional reconstruction method provided by the above embodiment of the present disclosure can quickly and accurately determine the weights of skinned mesh vertices, and improve the efficiency and accuracy of the reconstruction of the target three-dimensional human body model.

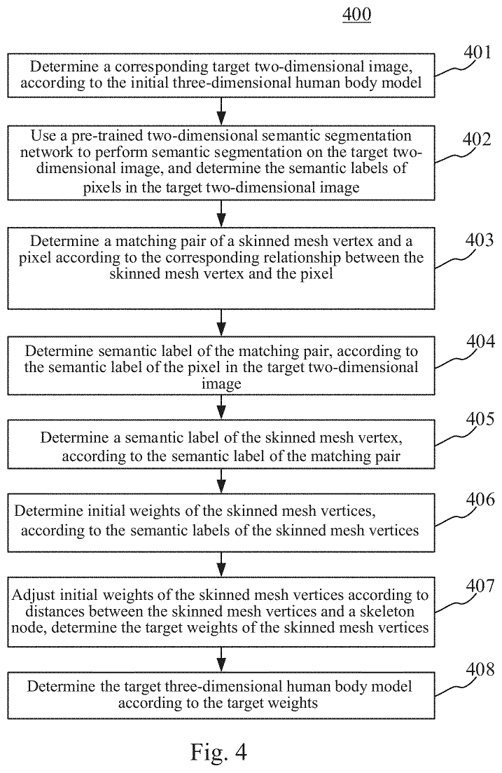

Referring to FIG. 4, which illustrates a flow 400 of a three-dimensional reconstruction method according to another embodiment of the present disclosure. As shown in FIG. 4, the method of this embodiment may include the following steps:

Step 401, determining, based on an initial three-dimensional human body model, a target two-dimensional image corresponding to the three-dimensional human body model.

In this embodiment, the corresponding target two-dimensional image may be determined by rendering the initial three-dimensional human body model. The target two-dimensional image may include various parts of the human body.

Step 402, using a pre-trained two-dimensional semantic segmentation network to perform semantic segmentation on the target two-dimensional image, and determining the semantic labels of the pixels in the target two-dimensional image.

In this embodiment, the executive body may input the above target two-dimensional image into a pre-trained two-dimensional semantic segmentation network to implement semantic segmentation on the target two-dimensional image, and determine the semantic labels of the pixels in the target two-dimensional image. Compared with inputting the initial three-dimensional human body model directly into the pre-trained three-dimensional semantic segmentation network, this embodiment requires less computation and occupies less memory, so that the computation speed is faster.

Step 403, determining a matching pair of a skinned mesh vertex in the initial three-dimensional human body model and a pixel in the target two-dimensional image, according to a corresponding relationship between the skinned mesh vertex in the initial three-dimensional human body model and the pixel in the target two-dimensional image.

In this embodiment, the executive body may also acquire the corresponding relationships between the skinned mesh vertices in the initial three-dimensional human body model and the pixels in the target two-dimensional image. The above corresponding relationships may be obtained from the application that constructs the initial three-dimensional human body model. According to the above corresponding relationships, the executive body may correspond the skinned mesh vertices in the initial three-dimensional human body model to the pixels in the target two-dimensional image. A skinned mesh vertex and a pixel that corresponding to each other may be referred to as a matching pair.

Step 404: determining a semantic label of the matching pair, according to a semantic label of the pixel in the target two-dimensional image.

The executive body may determine the semantic label of each matching pair according to the semantic labels of the pixels in the target two-dimensional image. In more detail, for each matching pair, the executive body may determine K nearest neighbor pixels in the target two-dimensional image that are closest to the pixel in the current matching pair, and then select the semantic label of the current matching pair by means of voting.

Step 405: determining a semantic label of a skinned mesh vertex, according to the semantic label of the matching pair.

The executive body may use the semantic label of the matching pair as the semantic label of the skinned mesh vertex in the matching pair.

In this embodiment, the semantic labels of the respective skinned mesh vertices are determined by semantically segmenting the target two-dimensional image. The accuracy of semantic segmentation is higher, compared with directly semantically segmenting the initial three-dimensional human body model, so the accuracy of semantic segmentation for some special human bodies (such as those who wear loose clothes that cause the outline of clothes to be inconsistent with the outline of human skin) is higher.

Step 406: determining initial weights of the skinned mesh vertices, according to the semantic labels of the skinned mesh vertices.

In this embodiment, after determining the semantic labels of the skinned mesh vertices, the executive body may initialize the initial weights of the skinned mesh vertices of the initial three-dimensional human body model. In more detail, the value of the initial weight may be between 0 and 1, indicating that when one or more bones change in motion, the weighted motion of the corresponding surface vertices changes. During initialization, the executive body may set the weight of the corresponding semantic label to 1. For example, the current semantic label of a skinned mesh vertex is body, and the skin weight vector is (head, body, left arm, right arm), then the initialized weight vector is: (0, 1, 0, 0).

Step 407: adjusting the initial weights of the skinned mesh vertices according to distances between the skinned mesh vertices and a skeleton node, and determining the target weights of the skinned mesh vertices.

The executive body also needs to adjust the initial weights of the skinned mesh vertices. In more detail, the executive body may adjust the initial weight of a skinned vertex according to the distance between the skinned vertex and a skeleton node. The adjusted weight may be used as a target weight. When adjusting, the executive body may set the weight of a skinned mesh vertex that is closer to the bone node at the joint to be smaller. For example, the weight of a skinned mesh vertex closer to bone of the forearm is set as 1, and the weights of the skinned mesh vertices at the joint are attenuated in proportion to the distances from the bone, until being attenuated to 0.

In some optional implementations of this embodiment, the executive body may adjust the initial weights by the following steps: determining a candidate skinned mesh vertex among the skinned mesh vertices that are driven by a skeleton node at a joint; adjusting an initial weight of the candidate skinned mesh vertex, and determining the target weights of the skinned mesh vertices.

In this implementation, the executive body may first determine a skinned mesh vertex driven by the skeleton node at the joint from the skinned mesh vertices, and use it as the candidate skinned mesh vertex. Then, the executive body may adjust the initial weights of the candidate skinned mesh vertex and determine the target weight of each skinned mesh vertex. in more detail, the weights of these candidate skinned mesh vertices are adjusted according to their distances from the bones.

Step 408: determining the target three-dimensional human body model according to the target weights.

The three-dimensional reconstruction method provided by the above embodiment of the present disclosure may use a mature two-dimensional semantic segmentation network to perform semantic segmentation on the target, two-dimensional image, and finally map the semantic segmentation result back to the three-dimensional human body model, which reduces the amount of calculation and memory consumption and improves the robustness of the algorithm.

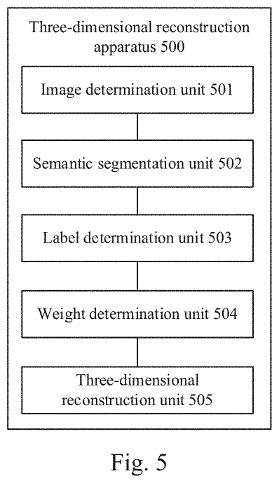

Further referring to FIG. 5. As an implementation of the methods shown in above figures, an embodiment of the present disclosure provides a three-dimensional reconstruction apparatus. The apparatus embodiment corresponds to the method embodiment shown in FIG. 2. In more detail, the apparatus may be applicable in various electronic devices.

As shown in FIG. 5, the three-dimensional reconstruction apparatus 500 of this embodiment includes: an image determination unit 501, a semantic segmentation unit 502, a label determination unit 503, a weight determination unit 504 and a three-dimensional reconstruction unit 505.

The image determination unit 501 is configured to determine, based on an initial three-dimensional human body model, a target two-dimensional image corresponding to the three-dimensional human body model.

The semantic segmentation unit 502 is configured to semantically segment the target two-dimensional image, and determining semantic labels of pixels in the target two-dimensional image.

The label determination unit 503 is configured to determine semantic labels of skinned mesh vertices according to corresponding relationships between the skinned mesh vertices in the initial three-dimensional human body model and the pixels in the target two-dimensional image.

The weight determination unit 504 is configured to determine target weights of the skinned mesh vertices according to the semantic labels of the skinned mesh vertices.

The three-dimensional reconstruction unit 505 is configured to determine a target three-dimensional human body model according to the target weights.

In some optional implementations of this embodiment, the semantic segmentation unit 502 may be further configured to: use a pre-trained two-dimensional semantic segmentation network to perform semantic segmentation on the target two-dimensional image, and determining the semantic labels of the pixels in the target two-dimensional image.

In some optional implementations of this embodiment, the label determination unit 503 may be further configured to: a matching pair of a skinned mesh vertex in the initial three-dimensional human body model and a pixel in the target two-dimensional image, according to a corresponding relationship between the skinned mesh vertex in the initial three-dimensional human body model and the pixel in the target two-dimensional image; determine a semantic label of the matching pair, according to a semantic label of the pixel in the target two-dimensional image; and determine a semantic label of the skinned mesh vertex in the initial three-dimensional human body model, according to the semantic label of the matching pair.

In some optional implementations of this embodiment, the weight determination unit 504 may be further configured to: determine initial weights of the skinned mesh vertices, according to the semantic labels of the skinned mesh vertices; adjust the initial weights of the skinned mesh vertices according to distances between the skinned mesh vertices and a skeleton node, and determining the target weights of the skinned mesh vertices.

In some optional implementations of this embodiment, the weight determination unit 504 may be further configured to: determine a candidate skinned mesh vertex among the skinned mesh vertices, the candidate skinned mesh vertex is driven by the skeleton node at a joint; adjust an initial weight of the candidate skinned mesh vertex, and determining the target weight of the skinned mesh vertex.

It should be understood that the units 501 to 505 described in the three-dimensional reconstruction apparatus 500 correspond to respective steps in the method described with reference to FIG. 2. Therefore, the operations and features described above with respect to the three-dimensional reconstruction method are also applicable to the apparatus 500 and the units included therein, and details are not described herein again.

In the technical solution of the present disclosure, the acquisition, storage and application of user's personal information involved are in compliance with relevant laws and regulations, necessary confidentiality measures have been taken, and public order and good customs are not violated.

According to embodiments of the present disclosure, an electronic device, a readable storage medium, and a computer program product are provided.

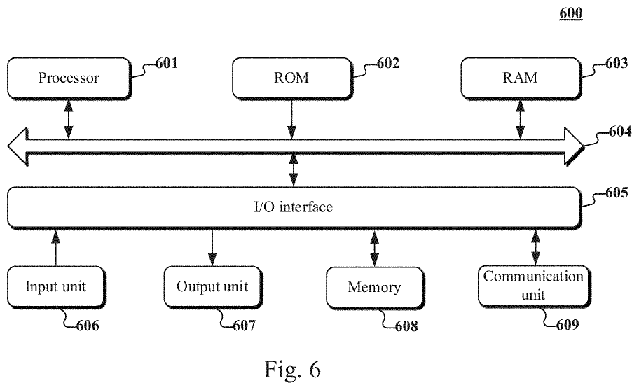

FIG. 6 is a block diagram of an exemplary electronic device 600 that may be used to implement the three-dimensional reconstruction method according to an embodiment of the present disclosure. The electronic device is intended to represent various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 6, the electronic device 600 includes a processor 601, which may perform various appropriate actions and processing according to a computer program stored in a read-only memory (ROM) 602 or a computer program loaded from a memory 608 into a random access memory (RAM) 603. In the RAM 603, various programs and data required for the operation of the electronic device 600 may also be stored. The processor 601, the ROM 602, and the RAM 603 are connected to each other through a bus 604. An input/output (I/O) interface 605 is also connected to the bus 604.

Multiple components in the device 600 are connected to the I/O interface 605, including: an input unit 606, such as a keyboard, a mouse, and the like; an output unit 607, such as various types of displays, speakers, and the like; and a memory 608, such as a magnetic disk, an optical disk, and the like; and a communication unit 609, such as a network card, a modem, a wireless communication transceiver, and the like. The communication unit 609 allows the device 600 to exchange information/data with other devices through a computer network such as the Internet and/or various telecommunication networks.

The processor 601 may be various general-purpose and/or special-purpose processing components with processing and computing capabilities. Some examples of processor 601 include, but are not limited to, central processing unit (CPU), graphics processing unit (GPU), various dedicated artificial intelligence (AI) computing chips, various processor that run machine learning model algorithms, digital signal processing (DSP), and any appropriate processor, controller, microcontroller, or the like. The processor 601 executes the various methods and processes described above, such as the three-dimensional reconstruction method. For example, in some embodiments, the three-dimensional reconstruction method may be implemented as a computer software program, which is tangibly contained in a machine-readable medium, such as the memory 608. In some embodiments, part or all of the computer program may be loaded and/or installed on the device 600 via the ROM 602 and/or the communication unit 609. When the computer program is loaded into the RAM 603 and executed by the processor 601, one or more steps of the three-dimensional reconstruction method described above can be executed. Alternatively, in other embodiments, the processor 601 may be configured to execute the three-dimensional reconstruction method through any other suitable means (for example, by means of firmware).

The various implementations of the systems and technologies described herein can be implemented in digital electronic circuit systems, integrated circuit systems, field programmable gate arrays (FPGA), application-specific integrated circuits (ASIC), application-specific standard products (ASSN), system-on-chip SOC, load programmable logic device (CPLD), computer hardware, firmware, software, and/or their combination. These various embodiments may include: being implemented in one or more computer programs, the one or more computer programs may be executed and/or interpreted on a programmable system including at least one programmable processor, the programmable processor can be a dedicated or general-purpose programmable processor that can receive data and instructions from the storage system, at least one input device, and at least one output device, and transmit the data and instructions to the storage system, the at least one input device, and the at least one output device.

The program code used to implement the method of the present disclosure can be written in any combination of one or more programming languages. The above program code can be packaged into a computer program product. These program codes or computer program product can be provided to the processors or controllers of general-purpose computers, special-purpose computers, or other programmable data processing devices, so that when the program codes are executed by the processors 601, the functions/operations specified in the flowcharts and/or block diagrams are implemented. The program code can be executed entirely on a machine or partly executed on the machine, partly executed on the machine and partly executed on a remote machine as an independent software package, or entirely executed on a remote machine or server.

In the context of the present disclosure, a machine-readable medium may be a tangible medium, which may contain or store a program for use by the instruction execution system, apparatus, or device or in combination with the instruction execution system, apparatus, or device. The machine-readable medium may be a machine-readable signal storage medium or a machine-readable storage medium. The machine-readable medium may include, but is not limited to, an electronic, magnetic, optical, electromagnetic, infrared, or semiconductor system, device, or apparatus, or any suitable combination of the foregoing. More specific examples of machine-readable storage media may include electrical connections based on one or more wires, portable computer disks, hard drives, random access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

In order to provide interaction with a user, the systems and technologies described herein may be implemented on a computer, the computer has: a display apparatus (e.g., CRT (cathode ray tube) or LCD (liquid crystal display) monitor for displaying information to the user; and a keyboard and a pointing apparatus (for example, a mouse or trackball), the user may use the keyboard and the pointing apparatus to provide input to the computer. Other kinds of apparatuses may also be used to provide interaction with the user; for example, the feedback provided to the user may be any form of sensory feedback (for example, visual feedback, auditory feedback, or tactile feedback); and may use any form (including acoustic input, voice input, or tactile input) to receive input from the user.

The systems and technologies described herein may be implemented in a computing system (e.g., as a data server) that includes back-end components, or a computing system (e.g., an application server) that includes middleware components, or a computing system (for example, a user computer with a graphical user interface or a web browser, through which the user may interact with the embodiments of the systems and technologies described herein) that includes front-end components, or a computing system that includes any combination of such back-end components, middleware components, or front-end components. The components of the system may be interconnected by any form or medium of digital data communication (e.g., a communication network). Examples of the communication network include: local area network (LAN), wide area network (WAN), and Internet.

The computer system may include a client and a server. The client and the server are generally far from each other and usually interact through a communication network. The client and server relationship is generated by computer programs operating on the corresponding computer and having client-server relationship with each other. The server may be a cloud server, also known as a cloud computing server or cloud host. It is a host product in the cloud computing service system to solve the defects of traditional physical host and Virtual Private Server (VPS), which are difficult to manage and weak in business scalability. The server may also be a distributed system server, or a server combined with a blockchain.

It should be understood that various forms of processes shown above may be used to reorder, add, or delete steps. For example, the steps described in embodiments of the present disclosure may be performed in parallel, sequentially, or in different orders, as long as the desired results of the technical solution disclosed in the present disclosure can be achieved, no limitation is made herein.

The above embodiments do not constitute a limitation on the protection scope of the present disclosure. Those skilled in the art should understand that various modifications, combinations, sub-combinations and substitutions can be made according to design requirements and other factors. Any modification, equivalent replacement and improvement made within the spirit and principle of this disclosure shall be included in the protection scope of this disclosure.

What is claimed is:

1. A three-dimensional reconstruction method, comprising:
determining, based on an initial three-dimensional human body model, a target two-dimensional image corresponding to the three-dimensional human body model;
semantically segmenting the target two-dimensional image, and determining semantic labels of pixels in the target two-dimensional image;
determining semantic labels of skinned mesh vertices according to corresponding relationships between the skinned mesh vertices in the initial three-dimensional human body model and the pixels in the target two-dimensional image;
determining target weights of the skinned mesh vertices according to the semantic labels of the skinned mesh vertices; and
determining a target three-dimensional human body model according to the target weights.

2. The method of claim 1, wherein the semantically segmenting the target two-dimensional image, and determining the semantic labels of the pixels in the target two-dimensional image, comprises:
using a pre-trained two-dimensional semantic segmentation network to perform semantic segmentation on the target two-dimensional image, and determining the semantic labels of the pixels in the target two-dimensional image.

3. The method of claim 1, wherein the determining the semantic labels of the skinned mesh vertices according to the corresponding relationships between the skinned mesh vertices in the initial three-dimensional human body model and the pixels in the target two-dimensional image, comprises:
determining a matching pair of a skinned mesh vertex in the initial three-dimensional human body model and a pixel in the target two-dimensional image, according to a corresponding relationship between the skinned mesh vertex in the initial three-dimensional human body model and the pixel in the target two-dimensional image;
determining a semantic label of the matching pair, according to a semantic label of the pixel in the target two-dimensional image; and
determining a semantic label of the skinned mesh vertex in the initial three-dimensional human body model, according to the semantic label of the matching pair.

4. The method of claim 1, wherein the determining the target weights of the skinned mesh vertices according to the semantic labels of the skinned mesh vertices, comprises:
determining initial weights of the skinned mesh vertices, according to the semantic labels of the skinned mesh vertices; and
adjusting the initial weights of the skinned mesh vertices according to distances between the skinned mesh vertices and a skeleton node, and determining the target weights of the skinned mesh vertices.

5. The method of claim 4, wherein the adjusting the initial weights of the skinned mesh vertices according to the distances between the skinned mesh vertices and the skeleton node, and determining the target weights of the skinned mesh vertices, comprising:
determining a candidate skinned mesh vertex among the skinned mesh vertices, wherein the candidate skinned mesh vertex is driven by the skeleton node at a joint; and
adjusting an initial weight of the candidate skinned mesh vertex, and determining the target weight of the skinned mesh vertex.

6. A three-dimensional reconstruction apparatus, comprising:
at least one processor; and
a memory, in communication connection with the at least one processor; wherein, the memory stores instructions executable by the at least one processor, the instructions, when executed by the at least one processor, cause the at least one processor to implement operations, the operations comprising:
determining, based on an initial three-dimensional human body model, a target two-dimensional image corresponding to the three-dimensional human body model;
semantically segmenting the target two-dimensional image, and determining semantic labels of pixels in the target two-dimensional image;
determining semantic labels of skinned mesh vertices according to corresponding relationships between the skinned mesh vertices in the initial three-dimensional human body model and the pixels in the target two-dimensional image;
determining target weights of the skinned mesh vertices according to the semantic labels of the skinned mesh vertices; and
determining a target three-dimensional human body model according to the target weights.

7. The apparatus of claim 6, wherein the semantically segmenting the target two-dimensional image, and determining the semantic labels of the pixels in the target two-dimensional image, comprises:
using a pre-trained two-dimensional semantic segmentation network to perform semantic segmentation on the target two-dimensional image, and determining the semantic labels of the pixels in the target two-dimensional image.

8. The apparatus of claim 6, wherein the determining the semantic labels of the skinned mesh vertices according to the corresponding relationships between the skinned mesh vertices in the initial three-dimensional human body model and the pixels in the target two-dimensional image, comprises:
determining a matching pair of a skinned mesh vertex in the initial three-dimensional human body model and a pixel in the target two-dimensional image, according to a corresponding relationship between the skinned mesh vertex in the initial three-dimensional human body model and the pixel in the target two-dimensional image;
determining a semantic label of the matching pair, according to a semantic label of the pixel in the target two-dimensional image; and
determining a semantic label of the skinned mesh vertex in the initial three-dimensional human body model, according to the semantic label of the matching pair.

9. The apparatus of claim 6, wherein the determining the target weights of the skinned mesh vertices according to the semantic labels of the skinned mesh vertices, comprises:
determining initial weights of the skinned mesh vertices, according to the semantic labels of the skinned mesh vertices; and
adjusting the initial weights of the skinned mesh vertices according to distances between the skinned mesh vertices and a skeleton node, and determining the target weights of the skinned mesh vertices.

10. The apparatus of claim 9, wherein the adjusting the initial weights of the skinned mesh vertices according to the distances between the skinned mesh vertices and the skeleton node, and determining the target weights of the skinned mesh vertices, comprising:
determining a candidate skinned mesh vertex among the skinned mesh vertices, wherein the candidate skinned mesh vertex is driven by the skeleton node at a joint; and
adjusting an initial weight of the candidate skinned mesh vertex, and determining the target weight of the skinned mesh vertex.

11. A non-transitory computer readable storage medium, which stores computer instructions, the computer instructions when executed by a computer cause the computer to execute operations, the operations comprising:
determining, based on an initial three-dimensional human body model, a target two-dimensional image corresponding to the three-dimensional human body model;
semantically segmenting the target two-dimensional image, and determining semantic labels of pixels in the target two-dimensional image;
determining semantic labels of skinned mesh vertices according to corresponding relationships between the skinned mesh vertices in the initial three-dimensional human body model and the pixels in the target two-dimensional image;
determining target weights of the skinned mesh vertices according to the semantic labels of the skinned mesh vertices; and
determining a target three-dimensional human body model according to the target weights.

12. The storage medium according to claim 11, wherein the semantically segmenting the target two-dimensional image, and determining the semantic labels of the pixels in the target two-dimensional image, comprises:
using a pre-trained two-dimensional semantic segmentation network to perform semantic segmentation on the target two-dimensional image, and determining the semantic labels of the pixels in the target two-dimensional image.

13. The storage medium according to claim 11, wherein the determining the semantic labels of the skinned mesh vertices according to the corresponding relationships between the skinned mesh vertices in the initial three-dimensional human body model and the pixels in the target two-dimensional image, comprises:
determining a matching pair of a skinned mesh vertex in the initial three-dimensional human body model and a pixel in the target two-dimensional image, according to a corresponding relationship between the skinned mesh vertex in the initial three-dimensional human body model and the pixel in the target two-dimensional image;
determining a semantic label of the matching pair, according to a semantic label of the pixel in the target two-dimensional image; and
determining a semantic label of the skinned mesh vertex in the initial three-dimensional human body model, according to the semantic label of the matching pair.

14. The storage medium according to claim 11, wherein the determining the target weights of the skinned mesh vertices according to the semantic labels of the skinned mesh vertices, comprises:
determining initial weights of the skinned mesh vertices, according to the semantic labels of the skinned mesh vertices; and
adjusting the initial weights of the skinned mesh vertices according to distances between the skinned mesh vertices and a skeleton node, and determining the target weights of the skinned mesh vertices.

15. The storage medium according to claim 14, wherein the adjusting the initial weights of the skinned mesh vertices according to the distances between the skinned mesh vertices and the skeleton node, and determining the target weights of the skinned mesh vertices, comprising:
determining a candidate skinned mesh vertex among the skinned mesh vertices, wherein the candidate skinned mesh vertex is driven by the skeleton node at a joint; and
adjusting an initial weight of the candidate skinned mesh vertex, and determining the target weight of the skinned mesh vertex.
